(19) United States
(12) Patent Application Publication
(10) Pub. No.: US 2012/0037239 A1
(43) Pub. Date: Feb. 16, 2012

(54) W.A.I.T. washpipe assembly install tool

(76) Inventor: William David Martin, Spring, TX (US)

(21) Appl. No.: 13/136,925

(22) Filed: Aug. 15, 2011

Related U.S. Application Data
(60) Provisional application No. 61/374,129, filed on Aug. 16, 2010.

(51) Int. Cl. B23P 19/00

(52) U.S. Cl. 137/15.01; 29/700

(57) ABSTRACT

Apparatus and method for installing and removing washpipe assemblies from a stem of a swivel/top drilling apparatus, including an installing and removing tool with support arms and a support plate structured and connected together into a unitary structure to conform to washpipe assembly dimensions.

### CROSS REFERENCE TO RELATED APPLICATIONS

This application is related to and claims priority to co-pending application Ser. No. 61/374,129 filed Aug. 16, 2010 entitled W.A.I.T. Washpipe Assembly Install Tool, inventor William D. Martin, which application is herein incorporated by reference in its entirety.

### FIELD OF THE INVENTION

This invention relates to washpipe assemblies, and more particularly, to an install/remove tool and method for washpipe assemblies.

### BACKGROUND OF THE INVENTION

A washpipe assembly WA comprises three major components: an upper retainer nut URN; a washpipe tube WPT; and a lower packing nut LPN. See FIG. 6. The washpipe assembly is used primarily in the rotary drilling industry and is common to all rotary swivels and top drive drilling machines. See FIGS. 8-12.

In normal operation a washpipe assembly is typically 15 feet above the work floor area atop a swivel/top drive. See FIG. 14, for convenient reference, of the common arrangement in the art. The top drive is suspended underneath and supported by a traveling block and sometimes includes a shock dampening traveling block hook. These are commonly known as the travelling assembly and are common to conventional drilling rigs. The travelling assembly may extend 20 feet to 30 feet directly above a swivel/top drive, making it impossible to remove or install a washpipe assembly using existing hoist apparatus and tools.

The most common sizes of washpipe assemblies are referenced to the washpipe tube internal dimension and overall length, and are commonly referred to as 3 inch and 4 inch short or tall washpipe assemblies. The majority of all rotary swivels/top drives use one of these sizes.

The function of the washpipe assembly is to allow a drilling media, typically fluid, to flow from a fixed entry point at the top of the rotary swivel/top drive to a rotating stem of the same, under pressure. The pressure is contained through a series of lip seals which are contained inside the upper packing nut and the lower packing nut of the washpipe assembly.

During normal use, the lip seals require replacement due to fatigue failure. When this occurs, the washpipe assembly must be removed from the drilling machine and replaced with a new washpipe assembly. Due to the confined space and tight clearances, the washpipe assembly must be removed and replace by hand. To do this the following procedure is used.

The lower washpipe nut is unscrewed completely from the idled rotating stem.

A metallic plate of approximately ⅛ inch thickness is placed between the lower packing nut and the idled rotating stem. (This plate will support the washpipe tube when the upper retainer nut is unscrewed.) The upper retainer nut is completely unscrewed, allowing the washpipe tube to rest on the metallic plate. At this time the entire washpipe assembly including the loose metallic plate must be removed all at the same time by hand.

The average weight of a 3 inch assembly is about 145 pounds and the weight of a 4 inch assembly is about 200 pounds. Due to space confinements of the working area atop the swivel/top drive only one person can perform the change out of a wash pipe assembly requiring that person to handle the referenced weights of the assembly by hand until the assembly is clear of the washpipe assembly area out from under the swivel/top drive bonnet.

A lifting sling affixed to a hoist is pushed through the washpipe tube so as to capture the upper and lower nut as they are not retained and can slide off. The entire assembly is then raised to a washpipe installation area.

A person stationed atop the swivel/top drive must now position the metallic plate of approximately ⅛ inch thickness atop the idled rotating stem. (This plate will support the new washpipe assembly temporarily.)

The same person must then remove a lifting sling from a new washpipe assembly, properly orient the washpipe assembly with the packing nuts facing in the proper direction and, the entire assembly being now vertical, carefully physically lift and install the new washpipe assembly underneath the bonnet, letting them rest on the previously positioned metallic plate.

The new upper washpipe nut is then started onto the connection above and screwed as tightly as possible.

The metallic plate is then slid from underneath the lower washpipe nut, is tied off or in some other way retained to keep from falling, and the new lower nut is then made up.

It is estimated that approximately 2 actual hours must be allowed to change out a 3 inch washpipe assembly, and 4 hours must be allowed to change out a 4 inch assembly equaling 6 man hours and 12 man hours respectively.

The dangers involved with this method include dropping objects from heights, falling objects from heights, back and various muscle strains from lifting heavy objects in awkward positions, pinched fingers, smashed fingers and hands and is considered one of the most dangerous maintenance requirements to personnel on a drilling rig.

Objectives of the instant invention are to provide safer, easier, more efficient means of installing and/or removing a washpipe assembly by combining a washpipe support (pancake plate) and a washpipe packing nut support and assembly retention system such that the combination is self-centering underneath a swivel/top drive bonnet and can be used with a rotary swivel/top drive washpipe assembly size and make and traveling assembly.

The instant invention has successfully undergone extensive testing in an actual drilling industry manufacturing environment, and has been used successfully more than sixty times saving an estimated 240 actual working hours equaling 720 man hours based on an average time of 4 hours per change out of the washpipe assembly of a 4″ bore tall washpipe assembly.

### SUMMARY OF THE INVENTION

The instant invention comprises a washpipe assembly handling tool with a washpipe assembly retention latch system. An attached washpipe support plate allows an entire washpipe assembly to be removed and/or installed without the need of physically handling the washpipe underneath, or out from underneath, a swivel/top drive bonnet assembly. The invention can utilize a hoist attached to the washpipe assembly install tool via a conventional pad eye welded to the tool, not shown in drawings, or utilize an optional lifting assembly OLA attached to the assembly tie rod, as shown in the drawings.

The instant invention allows a washpipe assembly to be positioned on an exact centerline during installation by “capturing” the outside radius of swivel/top drive main shaft threads with a lower assembly support arm while an assembly retention latch arm maintains the assembly at an exact centerline position, inset from the lower support arm, relative to the diameter of the main shaft threads. The instant inventive tool also allows a washpipe assembly to be carefully and effectively removed from a swivel/top drive bonnet.

### BRIEF DESCRIPTION OF THE DRAWINGS

A better understanding of the present invention can be obtained when the following detailed description of the preferred embodiments are considered in conjunction with the following drawings, in which:

FIG. 1 illustrates components of the instant assembly tool as attached to three different washpipe assemblies.

FIGS. 2, 3 and 4 illustrate drawings for both a tall and a short 3 inch model illustrating the plate and the arms and the means of attachment therebetween.

FIG. 5 illustrates a 3-arm washpipe assembly attachment tool.

FIGS. 6 and 7 illustrate a 3-arm washpipe assembly attachment tool attached to a washpipe assembly.

FIGS. 8 through 13 illustrate a washpipe assembly affixed to an assembly attachment tool, and fixed in turn to an optional lifting assembly and lifting pole, together with the relationship to the bonnet section of a top swivel/top drive assembly.

FIG. 14 illustrates common industry practice for arranging a swivel/top drive, a washpipe location, a travelling block and a lifting pole on a drilling rig.

The drawings are primarily illustrative. It would be understood that structure may have been simplified and details omitted in order to convey certain aspects of the invention. Scale may be sacrificed to clarity.

### DESCRIPTION OF THE PREFERRED EMBODIMENTS

A preferred embodiment of the instant washpipe assembly installation tool preferably comprises eight critical sub components, strategically placed and welded, or in the case of the latch, retained with a welded hinge pin, and one push button type removable retainer pin. All sub items that comprise the assembly are preferably of a 300 series Stainless Steel. A removable latch retainer pin is preferably manufactured using 17-4PH stainless steel. Sub-components, preferably common across all sizes of the tool, are:

a self-centering lower support arm LSA;

a washpipe support plate (pancake plate) WSP;

a washpipe assembly retainer latch WRL;

a washpipe assembly retainer arm WRA;

a removable retainer latch pin RLP;

a non-removable retainer latch hinge pin RHP;

a assembly tie rod/optional lift post ALP;

a assembly stiffener post ASP;

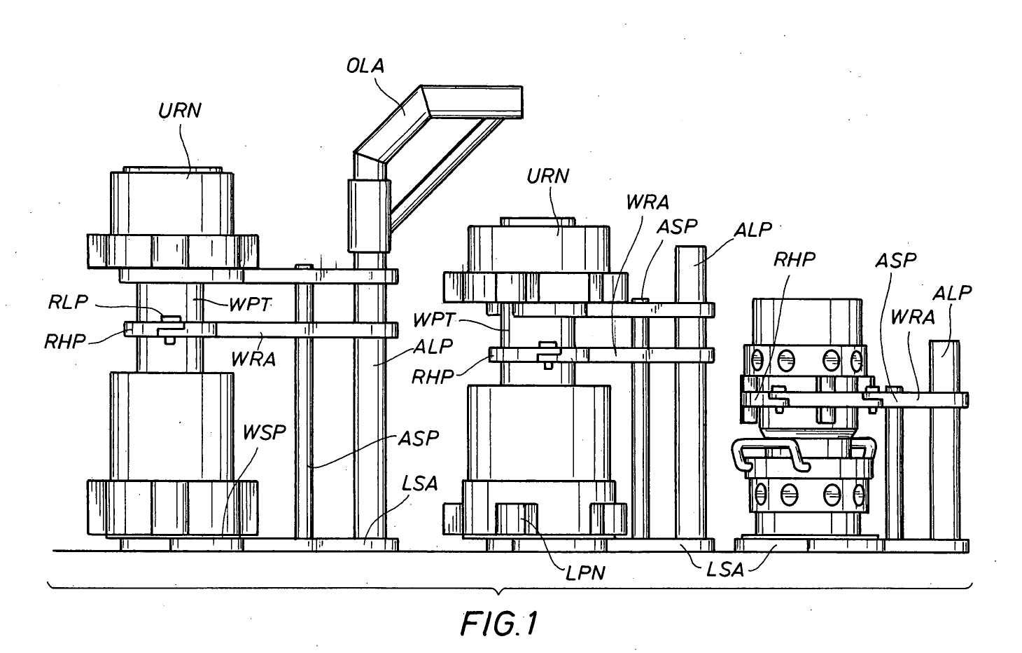

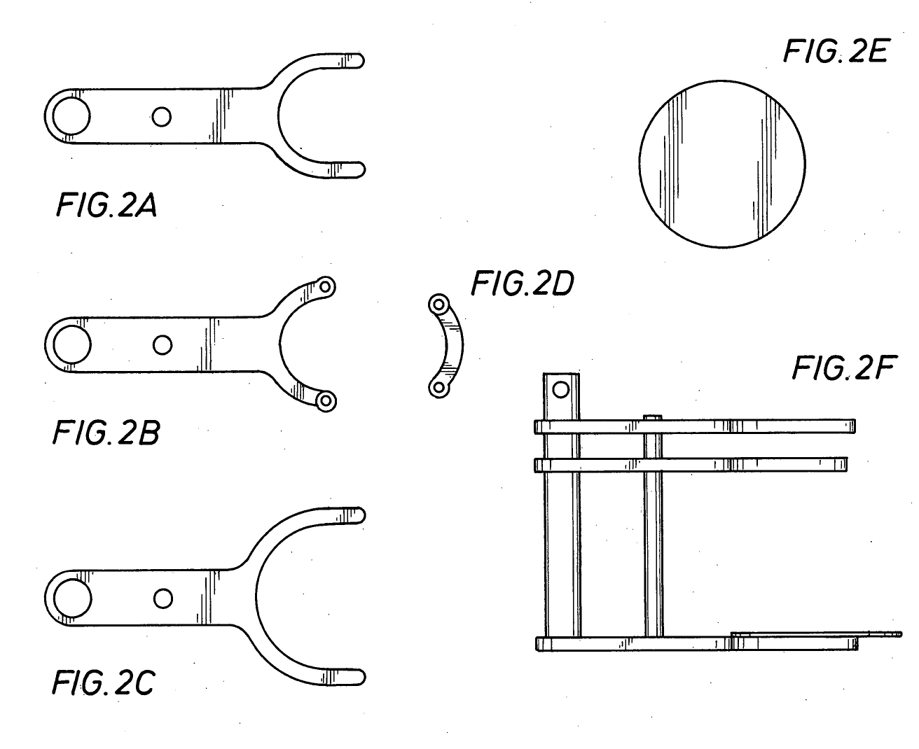

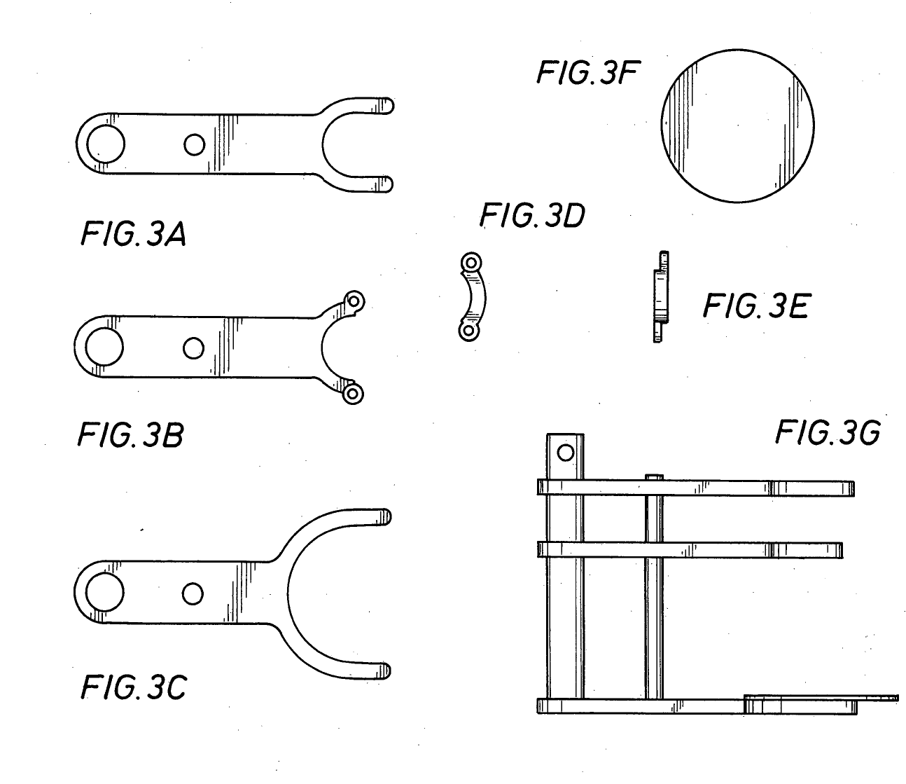

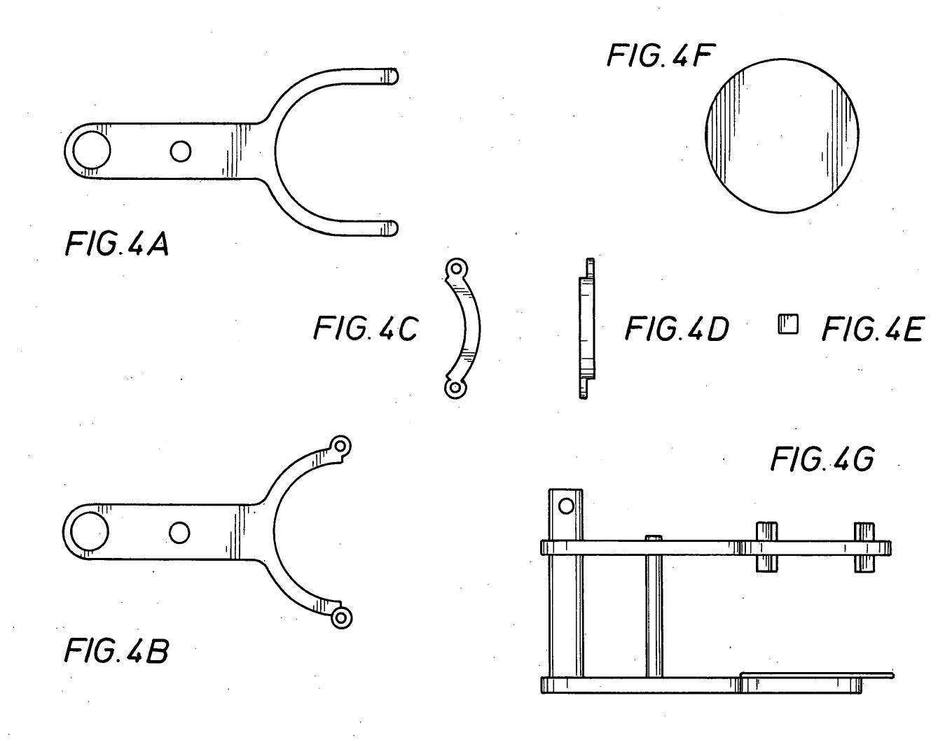

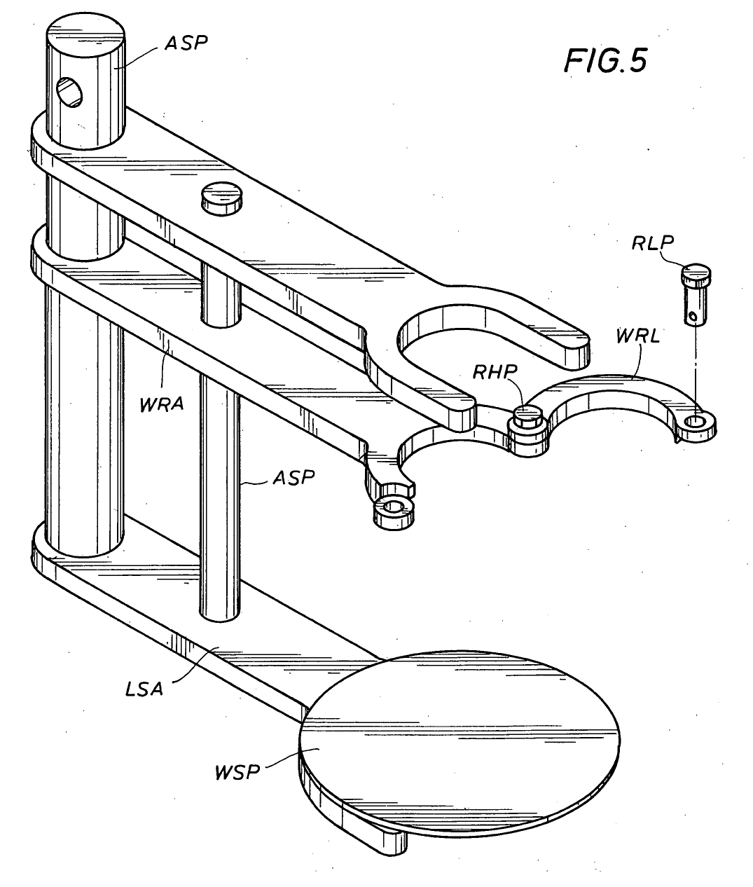

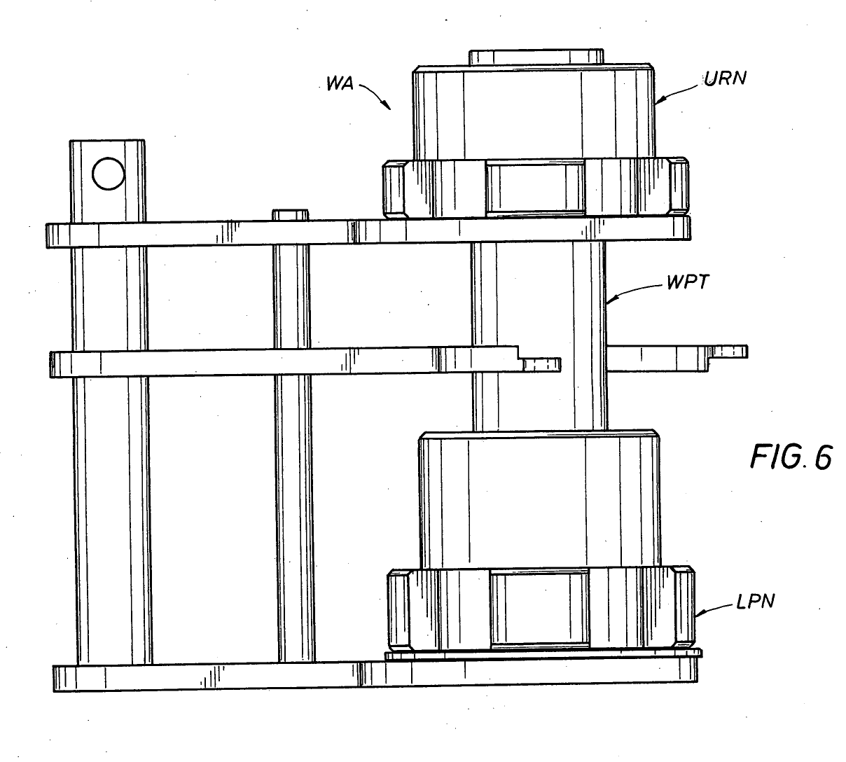

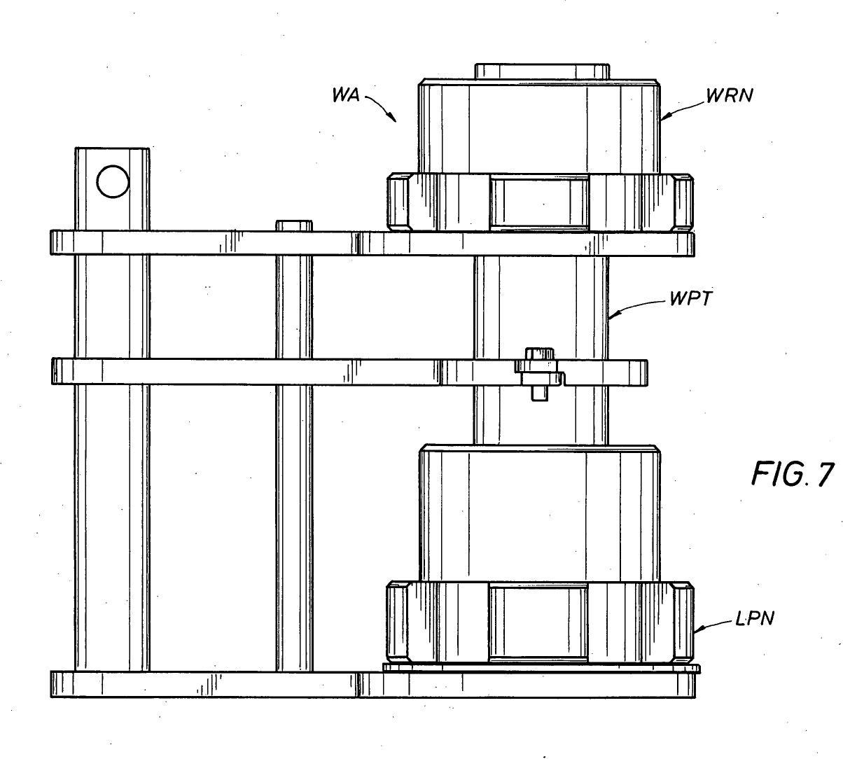

See FIGS. 1-5. The sub-components are preferably attached, as by welding, to form the W.A.I.T. tool, as illustrated in FIG. 5-7.

In operation, for preferred washpipe assembly removal, raise the W.A.I.T. tool to the washpipe area on top of the swivel. Loosen and unscrew completely the lower washpipe nut. Loosen the top washpipe nut. With the washpipe latch open slide the W.A.I.T. tool into place using the pancake plate to work underneath the lower washpipe nut, pushing the W.A.I.T. tool safely from behind with both hands, placed for instance on the large 2 inch post. The W.A.I.T. tool will “bottom out” against the threads of the main shaft, centering the tool with respect to the washpipe assembly. Close and pin the washpipe latch. Unscrew completely the top nut allowing it to rest on the top arm of the W.A.I.T tool. Using both hands pull the W.A.I.T. tool and washpipe assembly safely from behind, as with your hands on the large 2 inch lifting post. Continue pulling until the washpipe assembly is out from under the bonnet, taking care to keep yourself out from under the assembly at all times. Lower the assembly to the floor first before lowering yourself.

In operation, preferably to install a new washpipe assembly, set the W.A.I.T. tool on a flat, secure and reachable surface capable of supporting up to 300 pounds with the washpipe retainer latch open. Install a complete washpipe assembly onto the W.A.I.T. tool with the lower washpipe assembly nut facing down and resting on the pancake plate and the assembly upper nut facing up and resting on the upper support arm. Close the washpipe retainer latch and install a latch pin.

Follow company policy for preparing the threads on the swivel for a new washpipe installation. After installing a complete new washpipe assembly onto the W.A.I.T. tool, as described in the assembly procedures above, with the lower nut facing down and resting on the pancake plate and with the upper nut facing up and resting on the upper support arm horseshoe, close and pin the latch. Position a man on top of the swivel in a safe position to receive the assembly. Lift the tool and assembly to the top of the swivel. Grasp the W.A.I.T. tool with both hands, as at the 2 inch lifting post, and guide the assembly into place allowing the pancake plate to slide on top of the main shaft. The W.A.I.T. tool will “bottom out” against the threads of the main shaft when it is fully in place. Start the top washpipe assembly nut and screw it on as far as possible by hand. Remove the latch pin and slide the W.A.I.T. tool out from under the bonnet. Make up the bottom and top nuts of the washpipe assembly as per normal make up requirements. Lower the W.A.I.T. tool to the floor and disconnect the W.A.I.T. tool from the lifting pole of the original lifting assembly OLA. Clean and store all components in a safe manner for future use.

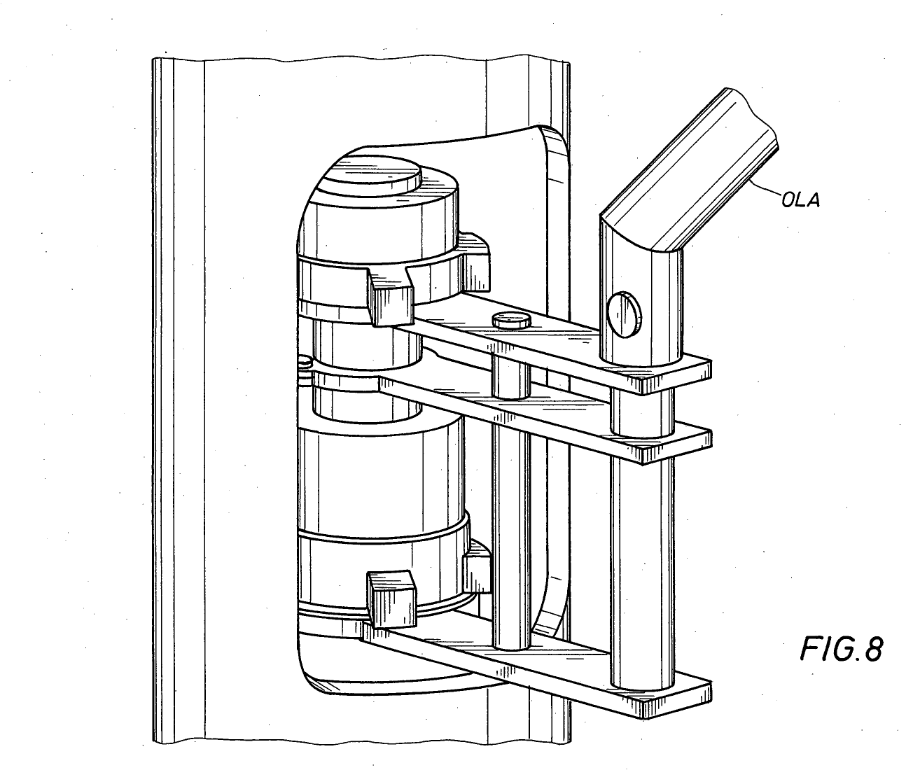

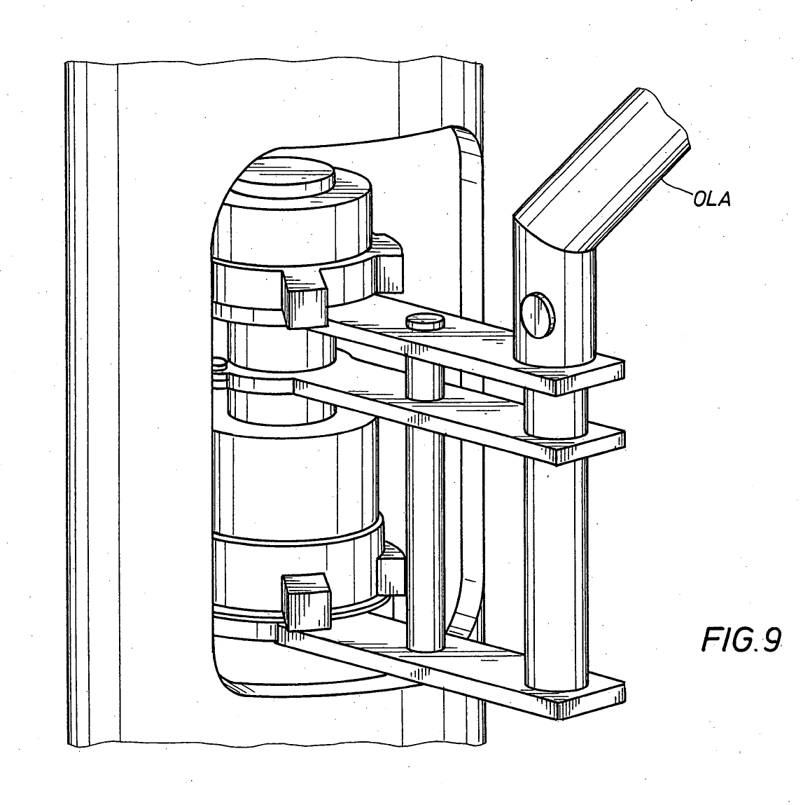

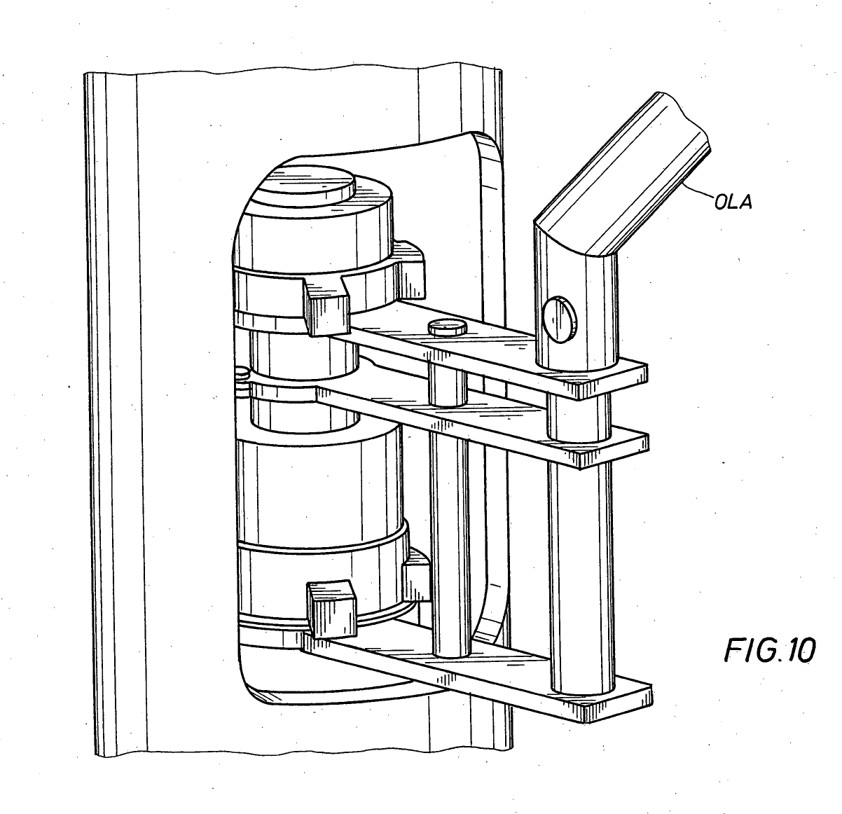

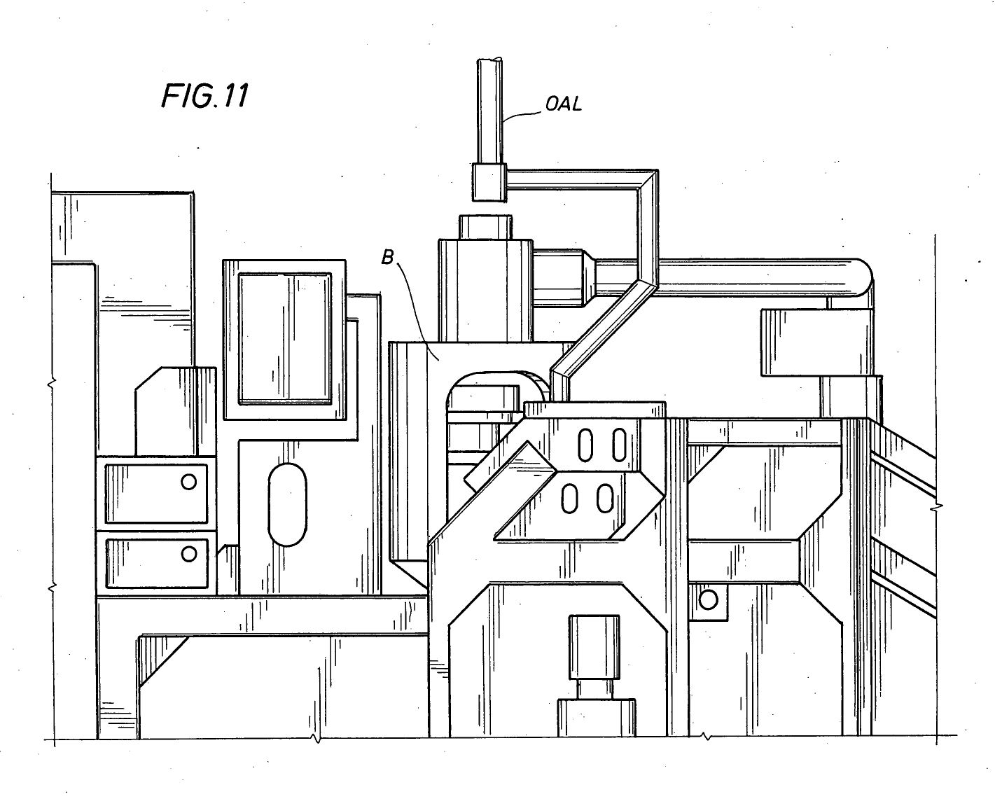

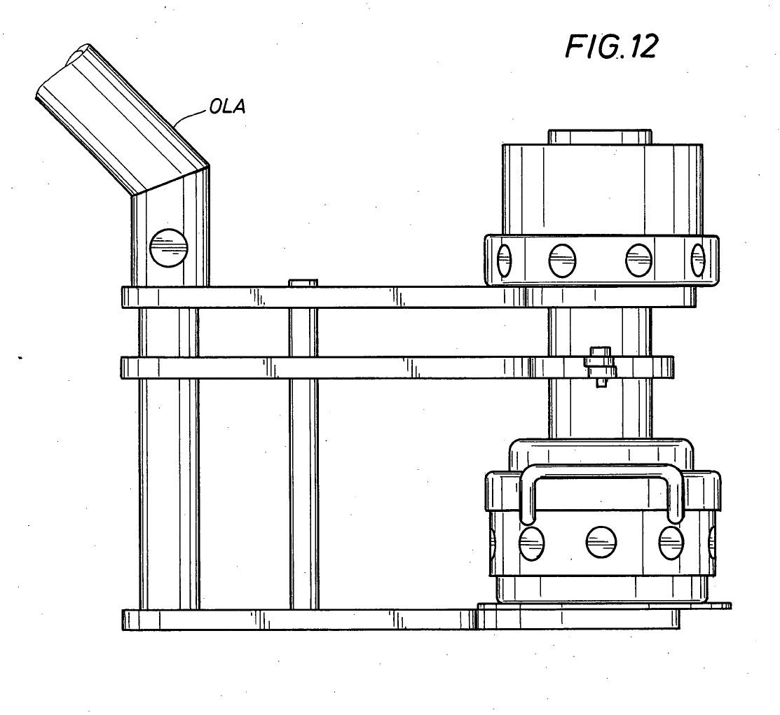

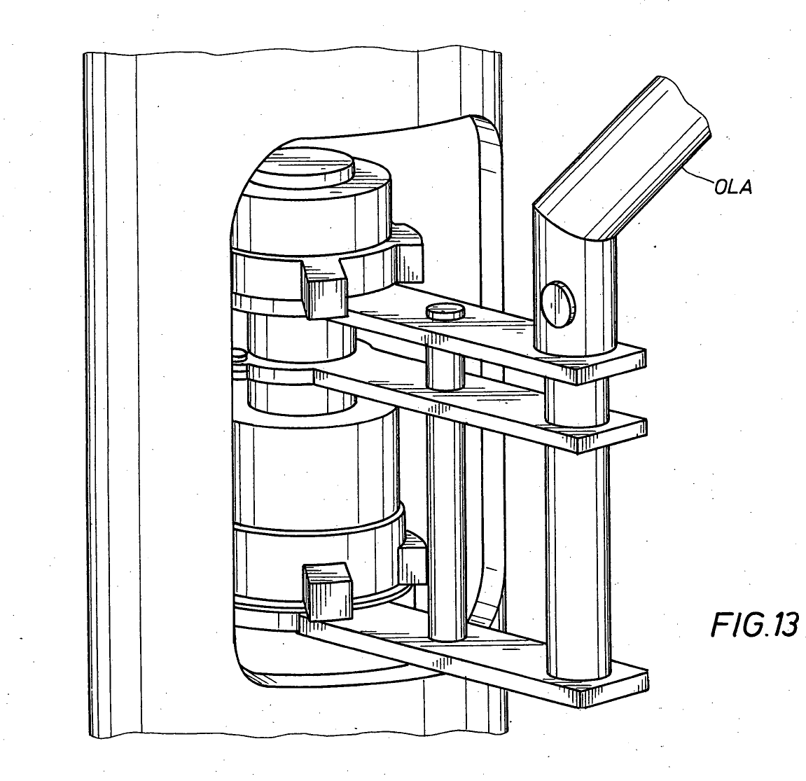

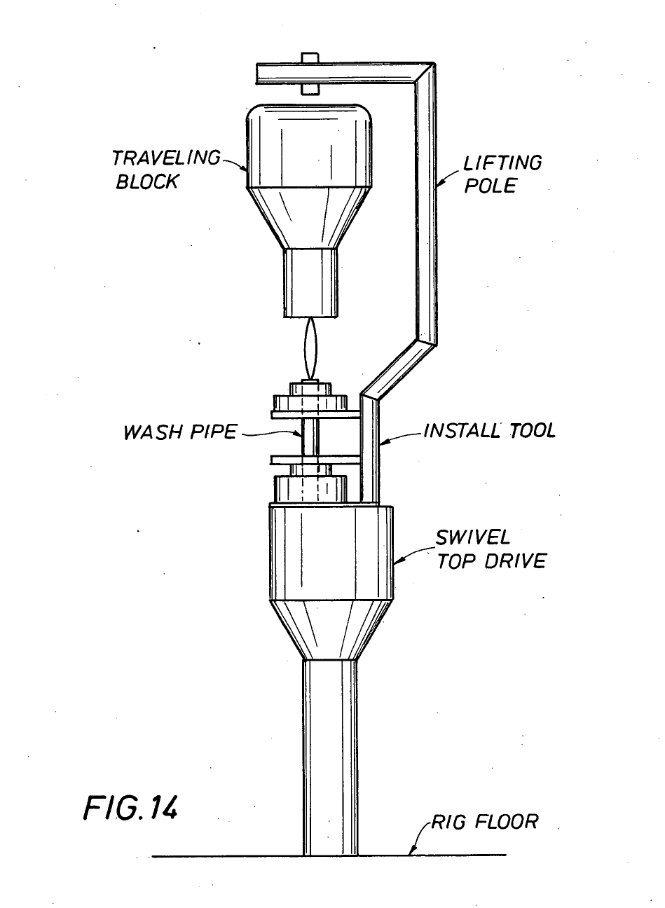

FIGS. 1 and 8-14 illustrate portions of a lifting pole of an original lifting assembly OLA. Such lifting assemblies are known in the art.

The foregoing description of preferred embodiments of the invention is presented for purposes of illustration and description, and is not intended to be exhaustive or to limit the invention to the precise form or embodiment disclosed. The description was selected to best explain the principles of the invention and their practical application to enable others skilled in the art to best utilize the invention in various embodiments. Various modifications as are best suited to the particular use are contemplated. It is intended that the scope of the invention is not to be limited by the specification, but to be defined by the claims set forth below. Since the foregoing disclosure and description of the invention are illustrative and explanatory thereof, various changes in the size, shape, and materials, as well as in the details of the illustrated device may be made without departing from the spirit of the invention. The invention is claimed using terminology that depends upon a historic presumption that recitation of a single element covers one or more, and recitation of two elements covers two or more, and the like. Also, the drawings and illustration herein have not necessarily been produced to scale.

What is claimed is:

1. Apparatus for installing and/or removing a washpipe assembly, comprising:
a lower support arm;
a washpipe assembly support plate;
a washpipe retainer arm having a moveable latch; and
an upper arm;
the arms and plate structured and connected together into a unitary structure to conform to washpipe assembly dimensions.

2. The apparatus of claim 1 wherein the lower support arm comprises a yolk structured to encompass a top portion of a drilling stem.

3. The apparatus of claim 2 wherein the washpipe retainer arm is structured in combination with the lower support arm such that the washpipe tube is centered over a drilling stem when the lower support arm securely encompasses top portions of the stem.

4. The apparatus of claim 1 wherein the upper arm comprises a yolk portion and is distanced from the lower support arm so as to permit an upper packing nut of a washpipe assembly to rest on the upper arm.

5. A method for installing a washpipe assembly onto a swivel/top drive stem or main shaft, comprising:
installing a washpipe assembly onto an assembly tool such that a lower washpipe assembly nut rests on a tool lower support plate and an upper washpipe assembly nut rests on an upper support arm of the tool;
latching a washpipe tube to a washpipe retainer arm of the tool, and
guiding the tool onto a swivel/top drive drilling stem such that a tool lower support arm bottoms out against a top portion of the swivel/top drive stem.

6. A method for removing a washpipe assembly from a top drive/swivel, stem or main shaft comprising:
unscrewing a lower washpipe nut of the washpipe assembly;
working a support plate of an assembly removal tool underneath the lower washpipe nut until a lower tool arm attached to the support plate bottoms out against a top portion of the swivel/top drive stem;
latching a washpipe tube of the washpipe assembly to a washpipe tube retainer arm of the tool; and pulling the tool and washpipe assembly out from the swivel/top drive stem.
